(19) United States
(12) Patent Application Publication
(10) Pub. No.: US 2002/0054074 A1
(43) Pub. Date: May 9, 2002

(54) Description scheme and browsing method for audio/video summary

(75) Inventors: Masaru Sugano, Tokyo (JP); Yasuyuki Nakajima, Saitama (JP); Hiromasa Yanagihara, Saitama (JP); Akio Yoneyama, Saitama (JP); Haruhisa Kato, Tokyo (JP)

Correspondence Address: ARMSTRONG,WESTERMAN & HATTORI, LLP, 1725 K STREET, NW., SUITE 1000, WASHINGTON, DC, 20006, US

(73) Assignee: KDDI Corporation, Tokyo (JP)

(21) Appl. No.: 09/863,352

(22) Filed: May 24, 2001

(30) Foreign Application Priority Data
May 26, 2000 (JP) 2000-157154

(51) Int. Cl. G09G 5/00

(52) U.S. Cl. 345/730; 345/716

(57) ABSTRACT

It is an objective of the invention to provide a description scheme of summary audio/video data, which is capable of presenting fast and advanced browsing.

In the description of slide summary components comprising portion (small segments or frames) of single or multiple content(s), the description relating to the temporal position or location (file name) of the original content(s) for specifying the link from the slide component to the original content is added to this description. For example, the position of the original segment in the original media file is described in the slide summary file as “media location” by the time code from the beginning of the file and others. The position of the slide component in the original media file is described in the summary file as the “media time” by the time code from the beginning of the file and others.

### BACKGROUND OF THE INVENTION

1. Field of the Invention

The present invention relates to description scheme and browsing method of summary data (outline) of compressed or uncompressed audio/video data (audio data, or video data, or audiovisual data), and particularly to description scheme and browsing method of summary data as feature data to be attached to audio/video data. The invention also relates to description scheme and browsing method of summary data of audio/video data capable of presenting fast and advanced browsing of audio/video data by presenting continuously small segments or frames of audio and video data arranged sequentially.

2. Description of the Related Art

The feature description of audio and video data is being standardized in MPEG-7 (Moving Picture Experts Group phase 7) of ISO and IEC at the present. In MPEG-7, in order to search efficiently compressed or uncompressed audio and video data, content descriptors, description schemes, and description definition language are being standardized.

In MPEG-7, feature description is being standardized from various viewpoints, and among those items, relating to the summary description for enabling fast and efficient browsing of audiovisual data, a description scheme is specified where temporal positions or file names of key clips are described sequentially in the feature description file. Though the key clip determination is out of standard, it can be performed, for example, by semantically dividing the audiovisual data into shots or scenes, and extracting significant images (i.e. key frames) that represent shots.

On the application side, for example, by presenting them continuously at specific or arbitrary temporal segments, fast browsing like slide show is enabled, and the summary of audio and video data can be presented. Such summary is called slide summary hereinafter.

Referring to FIG. 8 and FIG. 9, a conventional description scheme of slide summary data is explained. FIG. 8 is an example of a method for composing a slide summary of a certain media file P and describing the slide summary. First, when a media file of audio or video (assuming video herein) P is entered, a first shot or scene is defined by a shot or scene detection algorithm (step S51). By applying a key frame detection algorithm for this shot or scene, the key frame in the first shot or scene is determined (step S52).

The position of the determined key frame in the original media file is described in the slide summary description file as the “media time” by the frame number or time code from the file beginning (step S52′). While, in the slide summary description file, a slide component header is described at the beginning of each slide component (step S51′). Optionally, when saving the determined key frame as external file (step S53), the saved key frame file name is described in the slide summary description file as “slide component file name” (step S53′).

This is the procedure for describing the slide component for the first shot or scene, and this procedure is repeated to the final shot or scene of the media file P. To reduce the number of slide components, when detecting the shot or scene in the media file P at step S51, temporal sub-sampling may be applied.

FIG. 9A and FIG. 9B show examples of slide summary in the conventional slide summary description shown in FIG. 8. As shown in FIG. 9A and FIG. 9B, in the original content 61, scene 1, scene 2, scene 3, . . . are defined from the beginning, and each original segment 62 is supposed to be defined as time code. Slide components 63 are given as time code or external file name for each scene as shown in FIG. 9A and FIG. 9B. Time codes in the original content 61 are described as “media time” in the slide components 63.

In this case, an actual example of description of slide summary is shown in FIG. 9C. The slide summary of content is first displayed continuously and sequentially as KeyFrame1, KeyFrame2, KeyFrame3, . . . and so forth. As the display duration of each slide component, a specific time may be selected, or the time proportional to the duration of each scene may be assigned, or the time determined by the preset priority of the scene may be assigned.

Thus, in the prior art, the data showing the slide component belongs to which part of the original content is described, but there is no framework for describing the temporal segments of the scenes to which the slide components belong. of the conventional feature descriptions about the audio and video data, in the slide summary description, even in the case of audio and video data, only the visual data is specified in the form of key frames or others. For example, concerning the audio portion of audiovisual data, or the music data as data of audio only, nothing is specified about sequential description of the element corresponding to the key frame (for example, key audio clip).

As for the description scheme for describing the key frame as the slide component, the temporal position of the corresponding key frame in the original audio and video data can be described, but there exists no link to the temporal position in the original content from the slide component, such as transition to the shot in which the key frame is included, for example, from the key frame displayed as slide. Also, in the case of multiple media files regarded to be one content, similarly, there is no link for specifying the location of the original media file or file name from the slide component.

### SUMMARY OF THE INVENTION

It is hence an object of the invention to present a description scheme of summary data of audio/video data and a browsing method, in description of slide summary of slide components comprising part (small segments or frames) of single or multiple audiovisual content(s), capable of transferring to the corresponding original content during playback of a certain slide, for example, by adding the description relating to the temporal position or location (file name) of the original content for specifying the link to the content of the original from the slide components.

In order to accomplish the object, the invention is firstly characterized in a description scheme of summary data of at least one of audio data, video data, and audiovisual data (hereinafter called audio/video), wherein an audio/video slide is composed of single or multiple important portions of its content, relating to single or multiple compressed or uncompressed audio/video content(s), slide components of the audio/video slide are described sequentially, and this description includes the description about the link between the original audio/video contents and the slide components.

The invention is secondly characterized in a browsing method using the summary data of audio/video, wherein it is possible to transfer from playback of the audio/video slide to playback of the original audio/video content relating to the slide components of the audio/video slide, and it is also possible to transfer reversely from playback of original audio/video content to playback of audio/video slide.

According to the invention, concerning single or multiple audio and video contents, key audio or video clips belonging to them are used as slide components, and a slide summary arranging them sequentially is described efficiently, so that audio and video data can be browsed at high speed. Besides, by describing the link from the slide summary to the original content, an advanced slide summary can be composed.

### BRIEF DESCRIPTION OF THE DRAWINGS

FIG. 1 is a block diagram (single file) showing an example of slide summary composition in a first embodiment of the invention;

FIGS. 2A to C are diagrams showing the slide summary and its description examples in the slide summary composition shown in FIG. 1;

FIG. 3 is a flowchart showing browsing operation of the embodiment;

FIG. 4 is a block diagram (multiple files) showing an example of slide summary composition in a second embodiment of the invention;

FIGS. 5A through C are diagrams showing the slide summary and its description examples in the slide summary composition shown in FIG. 4;

FIGS. 6A through C are diagrams showing other slide summary and its description examples in the slide summary composition shown in FIG. 4;

FIG. 7 is a diagram showing various operations during slide summary playback realized by the invention;

FIG. 8 is a block diagram showing an example of slide summary composition in a prior art; and

FIGS. 9A through C are diagrams showing the slide summary and its description examples in the slide summary composition shown in FIG. 8.

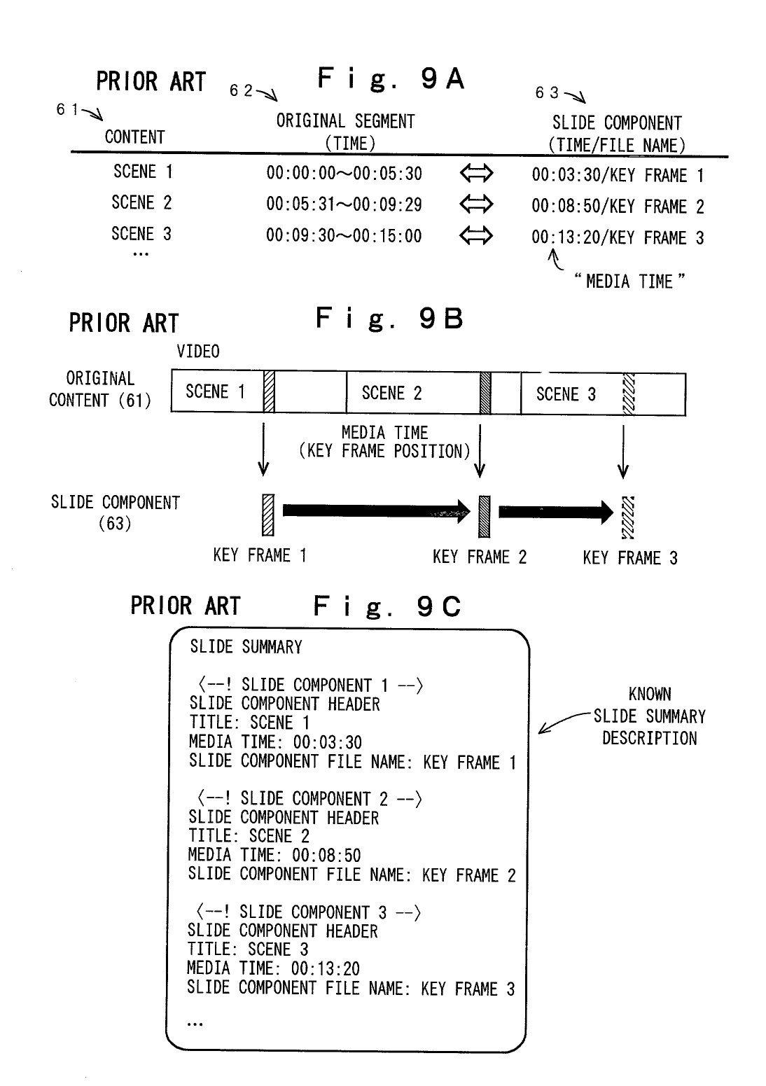

### DETAILED DESCRIPTION OF THE PREFERRED EMBODIMENT

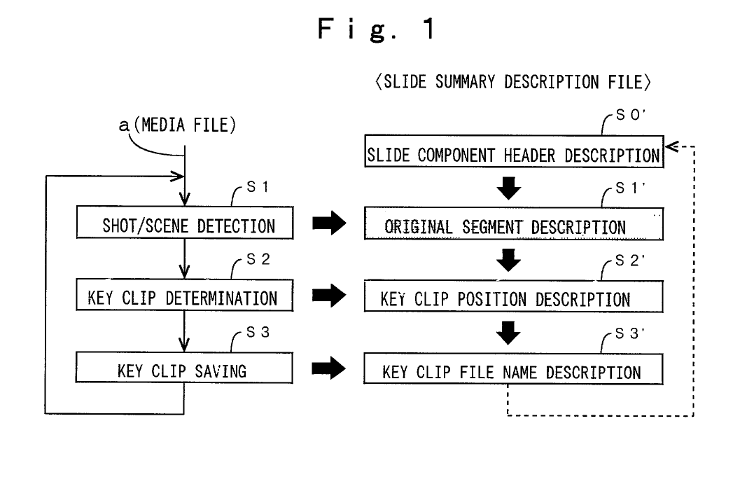

Referring now to the drawings, the invention is described in detail below. FIG. 1 shows a first embodiment of a slide summary composition by the slide summary description according to the invention. It is a feature of this embodiment that, concerning a single original audio/video (audio data, or video data, or audiovisual data) content, the description about the temporal segment in the original content is added to the description of slide components of the audio/video slide.

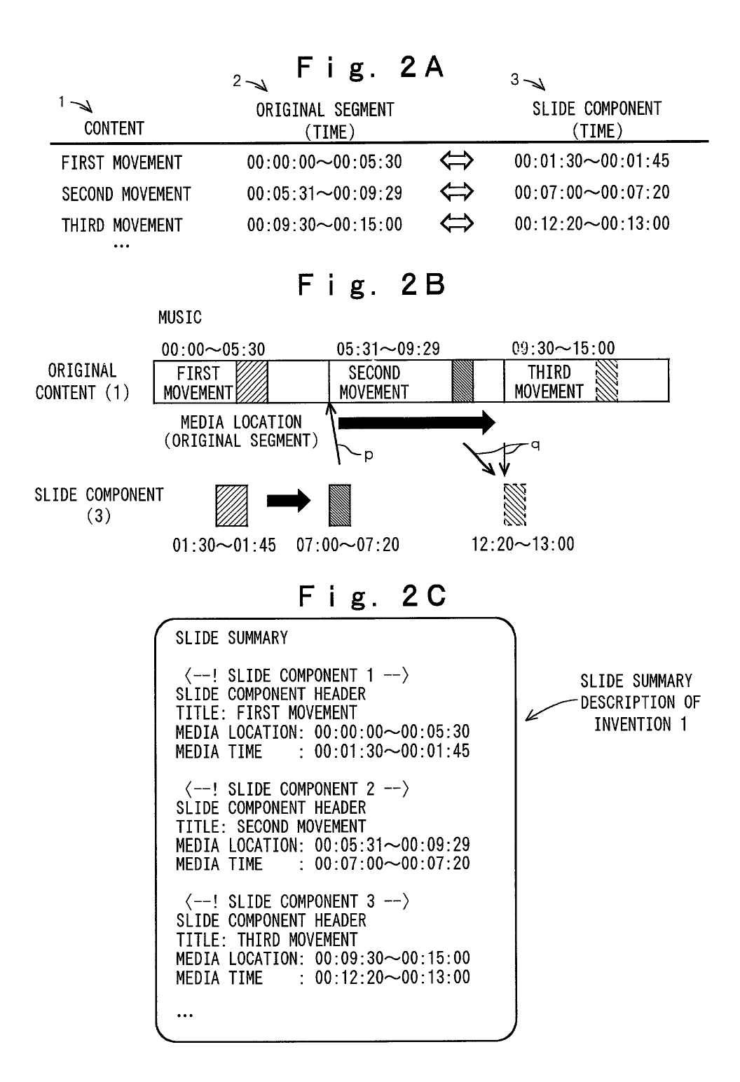

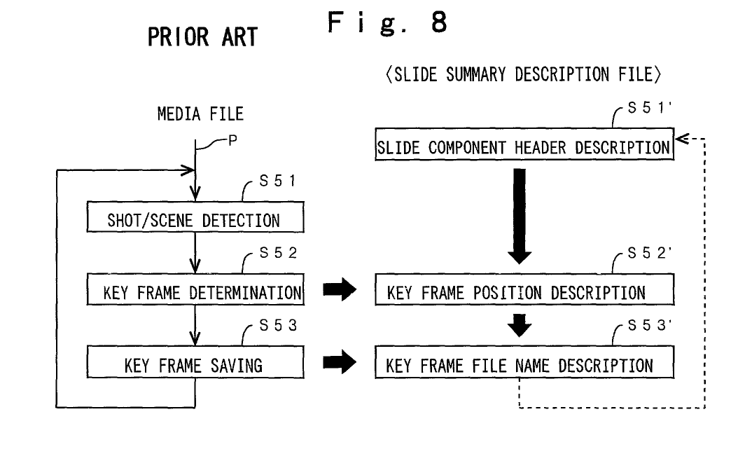

Same as in FIG. 8, when compressed or uncompressed single media file of audio or video (assuming audio herein) is entered, the first shot or scene is defined by the audio shot or scene detection algorithm (step S1). In the embodiment, as clearly shown in FIG. 2C below, the position of this shot or scene in the original media file is described in the slide summary description file as the “media location” by the time code from the beginning of the file and duration, that is, as the description about the temporal segment (step S1′). However, in the slide summary description file, a slide component header is described at the beginning of each slide component (step 50′).

By applying a key clip detection algorithm to this shot or scene, the key clip (the important clip) in the first shot or scene is determined (step S2). The position of the determined key clip in the original media file is described in the slide summary description file as the “media time” by the time code from the beginning of the file or others (step S2′).

Optionally, when saving the determined key clip as external file (step S3), the saved key clip file name is described in the slide summary description file as “slide component file name” (step S3′). As an example of saving in external file, it is assumed to encode at higher compression rate or decrease the sampling frequency in order to reduce the size of the file as the slide component. In the case of audiovisual data, meanwhile, only the audio portion may be saved as external file.

This is the procedure for describing the slide component for the first shot or scene, and this procedure is repeated up to the final shot or scene of the media file (a). Meanwhile, detection of shot or scene and determination of key clip can be done either automatically or manually, or both. In the explanation above, the description about the temporal segments in the original content is added to the description of the slide components of audio/video slide, but the separate files may be added instead of the temporal segments.

FIGS. 2A through C show examples of slide summary by slide summary description of the invention. In the original content 1, first movement, second movement, third movement and forth are defined from the beginning, and the segment 2 in the original content is defined as time code as shown in FIG. 2A and FIG. 2B. The slide component 3 is given as time code to each scene as shown in FIGS. 2A and B. However, the slide component 3 may be also specified as an external file.

In these slide components 3, the time code of the original content to which the slide components belong (in this example, each movement) is described as “media location.” FIG. 2c shows an example of actual description of slide summary. The slide summary of the content is usually played continuously and sequentially as 01:30 to 01:45, 07:00 to 07:20, 12:20 to 13:00, . . . , in normal situation, but when transition to the original content is signaled during playback of a certain slide component (for example, 07:00 to 07:20), it is transferred to the time code indicated in the original segment described as media location (see arrow p), and the corresponding original segment (second movement) can be played. Also, during playback of original contents, if transition to slide summary is signaled again, or when the playback of the original segment is terminated, the playback of the slide summary is started again from the slide described next to the slide summary at the origin of transition (see arrow q).

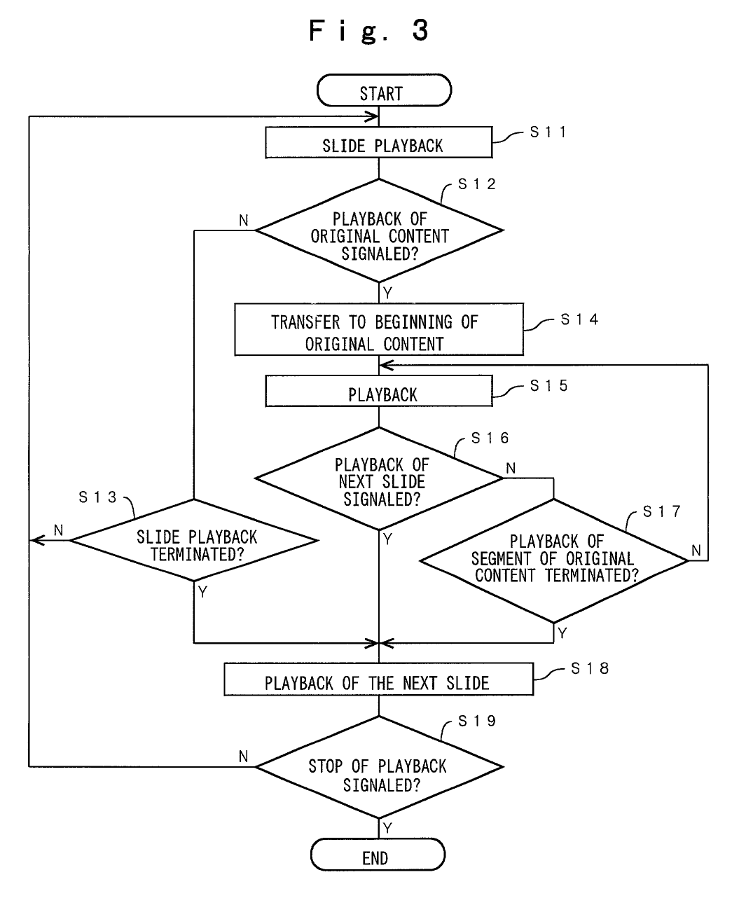

FIG. 3 is a flowchart showing the detail of the above browsing operation. While the slide component of the content is being played in the cycle of steps S11, S12, S13, when playback of original content is signaled at step S12, going to step S14 to transfer to the beginning of the original segment corresponding to the slide component being played, playback is started from the beginning of the segment of the original content at step S15. When playback of the slide component is signaled during playback of the original content (affirmative at step S16), going to step S18, the operation is transferred to playback of next slide component. When the playback of the segment of the original content is terminated (affirmative at step S17), going to step S18, the operation is transferred to playback of next slide component. Thus, according to the embodiment, transition is possible from playback of slide component to the corresponding segment of the original content. When stop of playback is signaled at step S19, the browsing operation is terminated.

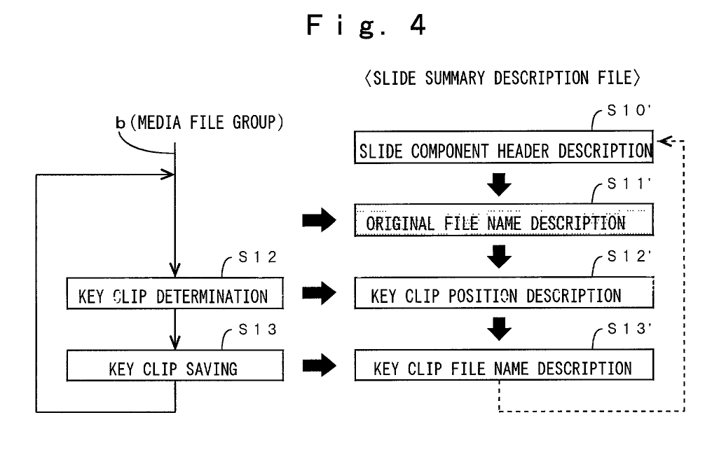

FIG. 4 shows a second embodiment of slide summary composing method by slide summary description according to the invention. It is a feature of this embodiment that, concerning multiple original audio/video contents, the description about the identifier of the original contents to which the slide component belongs is added, to the description of the slide components of the audio/video slide.

That is, what differs from the first embodiment (FIG. 1, FIG. 2) is that there are multiple media files of audio and/or video to be described. When the media file group (b) (assuming audio herein) is entered, the media file names are described in the slide summary description file as the “media location,” that is, as the description relating to the identifier of the original contents (step S11′). While, in the slide summary description file, the slide component header is described at the beginning of each slide component (step S10′).

Next, similar to FIG. 1, by applying a key clip detection algorithm to each file, the key clip in the first file is determined (step S12). The key clip can also be determined manually. The position of the determined key clip in the original media file is described in the slide summary description file as the “media time” by the time code from the beginning of the file or others (step S12′).

Optionally, when saving the determined key clip as external file (step S13), the saved key clip file name is described in the slide summary description file as “slide component file name” (step S13′). This is the procedure for describing the slide components in the first media file, and this procedure is repeated for all entered media files.

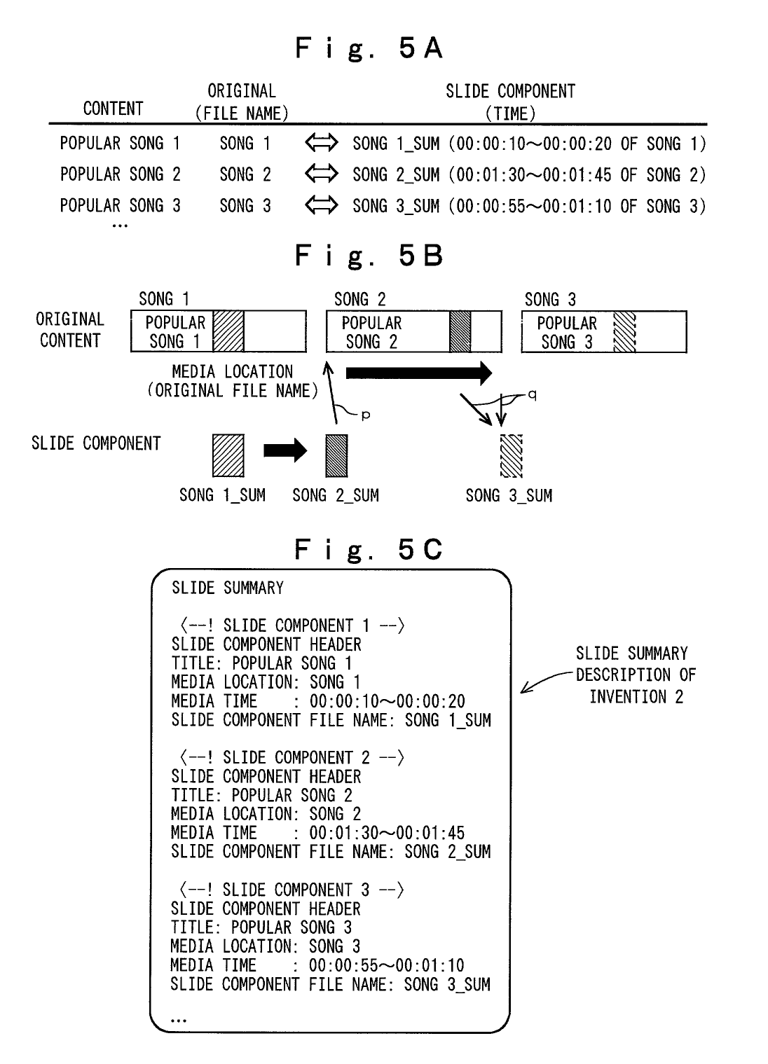

FIGS. 5A through C show specific examples of slide summary description according to the invention shown in FIG. 4. Suppose there are multiple media files such as popular song 1, popular song 2, popular song 3, . . . (that is, media file group (b)), and the file names are given as shown in FIGS. 5A and B as Song1, Song2, Song3, . . . . Slide components Song1-Sum, Song2-Sum, Song3-Sum, . . . are given as shown in FIGS. 5A, B as time codes corresponding to each file, and the separate slide components Song1-Sum, Song2-Sum, Song3-Sum, . . . are present as external files, respectively. In these slide components, the location (file path+file name, etc.) of the original media file (herein, each song) to which the slide component belongs is described as the “media location.”

An example of actual description of slide summary in this case is shown in FIG. 5C. The slide summary of the contents is usually played continuously and sequentially as Song1_sum, Song2_sum, Song3_sum, . . . , but when transition to the original content is signaled during playback of a certain slide component (for example, Song2_sum), it is transferred to the file (Song2) indicated by the file described as the media location, the corresponding file can be played from the beginning. Also, during playback of original file, if transition to slide summary is signaled again, or when the playback of the original file is terminated, the playback of the slide summary is started again from the slide described next to the slide summary at the origin of transition. This operation is the same as shown in FIG. 3.

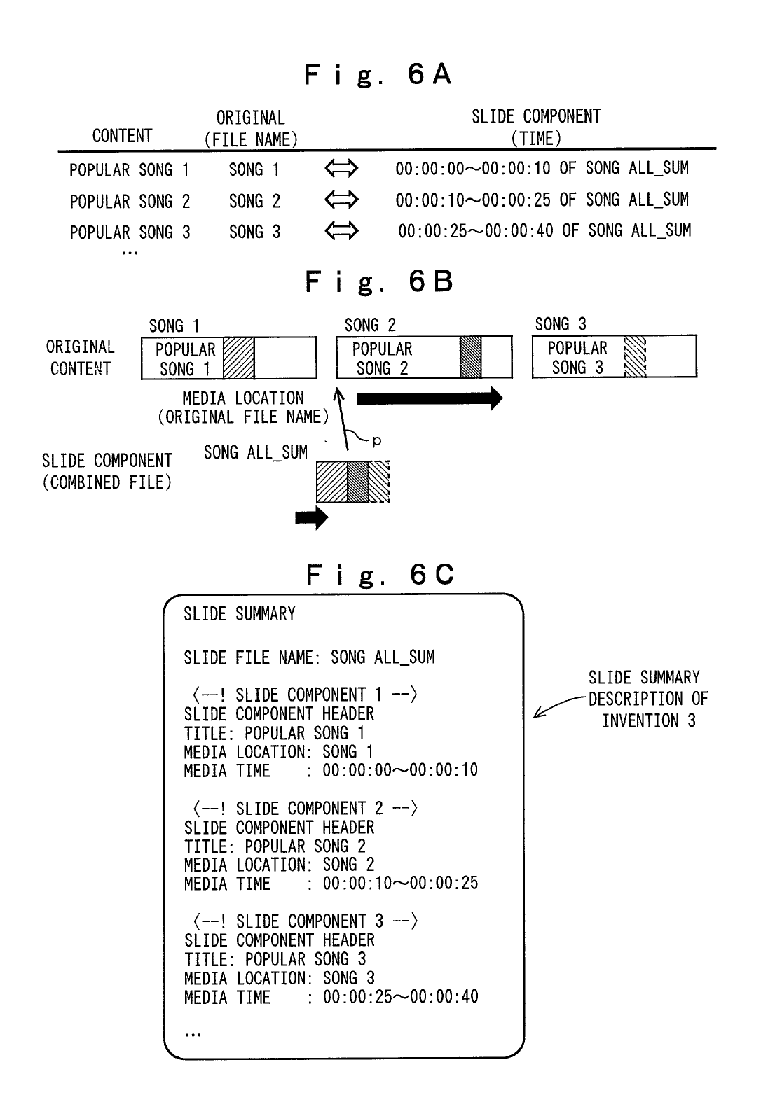

FIGS. 6A through C show a modified example of the embodiment in FIG. 5. In the modified example, as shown in FIG. 6B, each slide component of slide is given as one composite file, and the file name is given as SongAll_sum. Similar to the example in FIG. 5, the location (file path+file name, etc.) of the original media file to which the slide component belongs (herein, each song) is described as the “media location.” FIG. 6C shows an example of actual description of slide summary in the above case. The slide summary of this content is usually played continuously and sequentially as 00:00 to 00:10, 00:10 to 00:25, 00:25 to 00:40, . . . of SongAll_sum, but, as shown in FIG. 6B, when playback start p of the original content is signaled during playback of slide component (for example, 00:10 to 00:25 of SongAll_sum), the operation is transferred to the file (Song2) indicated by the file name described as media location, so that the corresponding file can be played from the beginning.

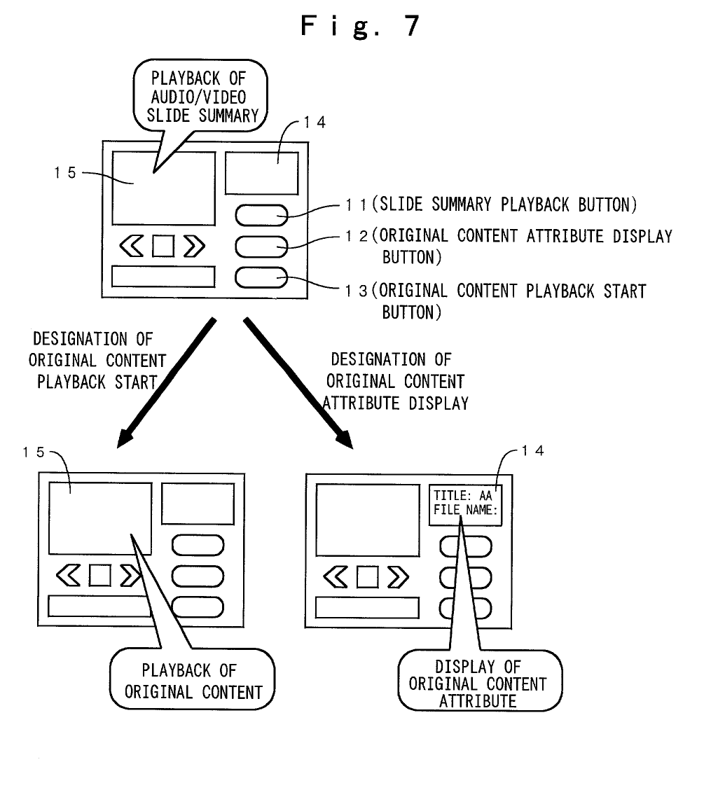

FIG. 7 shows an summary of a browsing device according to the invention. As shown in FIG. 7, when a slide summary playback button 11 is turned on, the audio/video slide summary is played. During playback of slide summary, for example, if an original content attribute display button 12 is pressed, and display of attributes (title, file name, etc.) of the original file is signaled, the description data about the original file (for example, title, file name) can be displayed in a character data display unit 14.

On the other hand, when an original content playback start button 13 is pressed during playback of slide summary and start of playback of original content is signaled, the segment of the original content or file relating to the slide summary can be played in a video data display unit 15.

Thus, in the invention, in addition to the data specifying the slide component belongs to which original content, the temporal segment such as shot/scene to which each slide component belongs is described, or the identifier (file name, etc.) is described if each slide component belongs to each different file, so that it is possible to reproduce alone the shot or scene to which the played slide belongs during playback of slide summary. Hence, an advanced audio/video slide summary can be presented.

As clearly shown from the description herein, according to the invention, the description relating to the link between the original audio/video contents and slide components can be included in the description of the slide components of slide summary of audio/video data. It is also possible to describe the slide summary relating to the multiple files. It is further possible to transfer to the original content (temporal segment or file) of the slide component relating to the slide component, and hence it is effective to realize fast and advanced browsing of audiovisual data when grasping the summary of the audiovisual data.

What is claimed is:

1. A description scheme of summary data of at least one of audio data, video data, and audiovisual data (hereinafter called audio/video),
wherein an audio/video slide is composed of single or multiple important portions of its content, relating to single or multiple compressed or uncompressed audio/video content(s), slide components of the audio/video slide are described sequentially, and this description includes the description about the link between the original audio/video contents and the slide components.

2. The description scheme of summary data of audio/video of claim 1,
wherein the slide components of the audio/video are single or multiple segments included in the original audio/video content(s), and the information about the segment is described sequentially.

3. The description scheme of summary data of audio/video of claim 1,
wherein the slide components of the audio/video are single or multiple segments included in the original audio/video content (s), and the segment is an separate file, and a set of files is described sequentially.

4. The description scheme of summary data of audio/video of claim 1,
wherein the slide components of the audio/video are single or multiple segments included in the original audio/video contents, a set of segments is integrated as one composite file, and the individual segments of the composite file are described sequentially.

5. The description scheme of summary data of audio/video of claim 1,
wherein if there are multiple original audio/video contents, the description about the link between the original contents and the slide components is the description about the identifier of the original contents to which the slide components belong.

6. The description scheme of summary data of audio/video of claim 1,
wherein if there is a single original audio/video content, the description about the link between the original content and the slide components is the description about the temporal segment in the original content of the slide components.

7. A browsing method using the summary data of audio/video described in the description scheme of claim 1,
wherein it is possible to transfer from playback of the audio/video slide to playback of the original audio/video content relating to the slide components of the audio/video slide, and it is also possible to transfer reversely from playback of original audio/video content to playback of audio/video slide.

8. A browsing method using the summary data of audio/video described in the description scheme of claim 1,
wherein it is possible to display the attribute data described about the corresponding original audio/video content by using the description data of the audio/video slide components during playback of the audio/video slide.

9. A browsing method using the summary data of audio/video described in the description scheme of claim 1,
wherein the corresponding original audio/video content is played by using the description data of the audio/video slide components during playback of the audio/video slide.
